(19) United States
(12) Patent Application Publication
(10) Pub. No.: US 2020/0354507 A1
(43) Pub. Date: Nov. 12, 2020

(54) SORBITOL-BASED CROSSLINKED OPTICAL POLYMERS

(71) Applicant: Novol, Inc., San Leandro, CA (US)

(72) Inventors: Monica BHATIA, San Leandro, CA (US); Jagdish JETHMALANI, San Leandro, CA (US); Sanjiban CHAKRABORTY, San Leandro, CA (US)

(21) Appl. No.: 16/936,854

(22) Filed: Jul. 23, 2020

Related U.S. Application Data
(63) Continuation-in-part of application No. PCT/US2019/015002, filed on Jan. 24, 2019.
(60) Provisional application No. 62/621,991, filed on Jan. 25, 2018.

(51) Int. Cl. C08G 18/75; C08G 18/73; C08G 18/38; C08G 18/32; C08G 18/24; G02B 1/04

(52) U.S. Cl. CPC C08G 18/758; C08G 18/73; C08G 18/3872; G02B 1/041; C08G 18/3206; C08G 18/242; C08G 18/3218

(57) ABSTRACT

Provided herein are crosslinked optical copolymers comprising a monomer derived from sorbitol, and a trifunctional linker. The crosslinked optical copolymers have a refractive index value greater than 1.5 and an Abbe value greater than 45. Also provided are methods for producing the provided crosslinked optical copolymers, and corrective lenses that include the provided crosslinked optical copolymers.

### CROSS-REFERENCE TO RELATED APPLICATION

The present application is a continuation-in-part of PCT Application No. PCT/US19/15002, filed Jan. 24, 2019, which claims the benefit of U.S. Provisional Patent Application No. 62/621,991 filed Jan. 25, 2018, the entireties of which are incorporated by reference herein.

### STATEMENT AS TO RIGHTS TO INVENTIONS MADE UNDER FEDERALLY SPONSORED RESEARCH AND DEVELOPMENT

This invention was made with government support under Small Business Innovation Research Program Phase I grant SBIR 1648374 and Phase II grant SBIR 1831288, both awarded by the National Science Foundation and Small Business Innovation Research Program Phase I grant SBIR 12497233 and Phase II grant SBIR 12815496, both awarded by the United States Department of Agriculture NIFA. The government has certain rights in the invention.

### BACKGROUND

Polymeric materials are used in an extremely wide range of products. A category of polymeric materials having demanding requirements is that used in optical applications. Such applications require materials having, for example, very high light transmittance, very low levels of haze, and good thermal and mechanical stability.

Traditional transparent polymers such acrylates, polystyrenes, and polycarbonates have been used in making optical lenses, eye glass lenses, head light covers, etc. These polymers can often be readily processed by injection or compression molding, or by machining a simple blank or block of the polymer to produce the optical product. Other processes for manufacturing these lenses include monomers or pre-polymers to be placed into a mold or cavity and polymerized directly to a shape of interest.

Current materials used to make polythiourethane thermosets with high optical properties have many drawbacks. These include the use of highly reactive and toxic monomers, high cost of other component chemicals, and difficulty in controlling optical properties such as transparency, refractive index, color, and Abbe value. The current state of the art ophthalmic thermosets have refractive indexes ranging from 1.6 to 1.74, with Abbe values ranging from 42 to 32, corresponding to high chromatic aberration which cannot be overcome unless the refractive index and the Abbe value are both compensated for. Hence, there is a need for developing new polyurethane copolymers and manufacturing processes that produce optical elements that demonstrate advantageous optical properties.

### BRIEF SUMMARY

In one aspect, crosslinked optical copolymers having a refractive index value greater than 1.5 and an Abbe value greater than 45 are provided. The crosslinked optical copolymers comprise a monomer derived from sorbitol. In some embodiments, the monomer is isosorbide or a derivative or stereoisomer thereof. In some embodiments, the mole fraction of the monomer in the crosslinked optical copolymer is from 40% to 50%. The crosslinked optical polymers can further comprise a trifunctional linker, known as a crosslinker. In some embodiments, the trifunctional linker is a triol. In some embodiments, the triol is glycerol. In some embodiments, the triol is a disulfone. In some embodiments, the disulfone is 2,2′-(2-hydroxypropane-1,3-diyldisulfonyl)bis(ethan-1-ol). In some embodiments, the mole fraction of the trifunctional linker in the crosslinked optical copolymer is from 1% to 20%.

In some embodiments, the crosslinked optical copolymers further comprise one or more difunctional linkers. In some embodiments, the mole fraction of the one or more difunctional linkers in the crosslinked optical copolymer is from 40% to 60%. In some embodiments, the one or more difunctional linkers are selected from the group consisting of diisocyanates and dithiocyanates. In some embodiments, the diisothiocyanates are selected from the group consisting of bis(4-isothiocyanatocyclohexyl)methane, 1,6-diisothiocyanatohexane, bis(4-isothiocyanatophenyl)methane, 5-isothiocyanato-1-(isothiocyanatomethyl)-1,3,3-trimethylcyclohexane, 1,4-diisothiocyanatocyclohexane, 1,4-diisothiocyanatobutane, and 1,3-bis(isothiocyanatomethyl)cyclohexane. In some embodiments, the diisocyanates are selected from the group consisting of bis(4-isocyanatocyclohexyl)methane (H₁₂MDI), 1,6-diisocyanatohexane (HMDI), bis(4-isocyanatophenyl)methane (MDI), 5-isocyanato-1-(isocyanatomethyl)-1,3,3-trimethylcyclohexane, 1,4-diisocyanatocyclohexane, 1,4-diisocyanatobutane, and 1,3-bis(isocyanatomethyl)cyclohexane. In some embodiments, the one or more difunctional linkers comprise H₁₂MDI. In some embodiments, the one or more difunctional linkers comprise HMDI. In some embodiments, the one or more difunctional linkers comprise bis(4-isocyanatophenyl)methane (MDI). In some embodiments, the one or more difunctional linkers comprise a first diisocyanate and a second diisocyanate, wherein the mole ratio of the first diisocyanate to the second diisocyanate in the crosslinked optical copolymer is from 0.3 to 1.7. In some embodiments, the first diisocyanate is H₁₂MDI and the second diisocyanate is HMDI. In some embodiments, the first diisocyanate is MDI and the second is a mixture of diisocyanates H12MDI and HMDI.

In some embodiments, the crosslinked optical copolymer has a number average molecular weight from 2000 to 50,000. In some embodiments, the crosslinked optical copolymer has a weight average molecular weight from 4000 to 75,000. In some embodiments, the crosslinked optical copolymer has a polydispersity index from 1.2 to 2.7.

In another aspect, the present disclosure provides optical elements comprising any of the provided crosslinked optical copolymers. In some embodiments, the optical elements are configured for use in microscopes or cameras, or as corrective lenses for use in eyeglasses.

In another aspect, the present disclosure provides methods for preparing a crosslinked optical copolymer. The methods comprise combining a monomer derived from sorbitol with one or more difunctional linkers to form a first reaction mixture. In some embodiments, the monomer is isosorbide or a derivative or stereoisomer thereof. In some embodiments, the one or more difunctional linkers are selected from the group consisting of diisocyanates and dithiocyanates. In some embodiments, the diisothiocyanates are selected from the group consisting of bis(4-isothiocyanatocyclohexyl)methane, 1,6-diisothiocyanatohexane, bis(4-isothiocyanatophenyl)methane, 5-isothiocyanato-1-(isothiocyanatomethyl)-1,3,3-trimethylcyclohexane, 1,4-diisothiocyanatocyclohexane, 1,4-diisothiocyanatobutane, and 1,3-bis(isothiocyanatomethyl)cyclohexane. In some embodiments, the diisocyanates are selected from the group consisting of bis(4-isocyanatocyclohexyl)methane (H₁₂MDI), 1,6-diisocyanatohexane (HMDI), bis(4-isocyanatophenyl)methane (MDI), 5-isocyanato-1-(isocyanatomethyl)-1,3,3-trimethylcyclohexane, 1,4-diisocyanatocyclohexane, 1,4-diisocyanatobutane, and 1,3-bis(isocyanatomethyl)cyclohexane. In some embodiments, the one or more difunctional linkers comprise H₁₂MDI. In some embodiments, the one or more difunctional linkers comprise HMDI. In some embodiments, the one or more difunctional linkers comprise bis(4-isocyanatophenyl)methane (MDI). In some embodiments, the one or more difunctional linkers comprise a first diisocyanate and a second diisocyanate, wherein the mole ratio of the first diisocyanate to the second diisocyanate in the crosslinked optical copolymer is from 0.3 to 1.7. In some embodiments, the first diisocyanate is H₁₂MDI and the second diisocyanate is HMDI. In some embodiments, the first diisocyanate is MDI and the second is a mixture of diisocyanates H12MDI and HMDI. The methods further comprise reacting the first reaction mixture under conditions suitable for forming a polymer composed of the monomer and the one or more difunctional linkers. The methods further comprise combining the polymer with a trifunctional linker to form a second reaction mixture. In some embodiments, the trifunctional linker is a triol. In some embodiments, the triol is glycerol. In some embodiments, the triol is a disulfone or 1,2,3-propanetrithiol. In some embodiments, the disulfone is 2,2′-(2-hydroxypropane-1,3-diyldisulfonyl)bis(ethan-1-ol). The methods further comprise reacting the second reaction mixture under conditions suitable for forming a crosslinked optical polymer, wherein the crosslinked optical polymer has a refractive index value greater than 1.5 and an Abbe value greater than 45.

In some embodiments, the first reaction mixture further comprises a metal catalyst. In some embodiments, the metal catalyst is an organotin compound. In some embodiments, the mole ratio of the monomer to the metal catalyst in the first reaction mixture is from 80 to 90.

### BRIEF DESCRIPTION OF THE DRAWINGS

FIG. 1 is a reaction scheme for a synthesis of a crosslinked optical copolymer including isosorbide, H₁₂MDI, HMDI, and glycerol in accordance with an embodiment.

FIG. 2 is a reaction scheme for a synthesis of a crosslinked optical copolymer including isosorbide, H₁₂MDI, HMDI, and 2,2′-(2-hydroxypropane-1,3-diyldisulfonyl)bis(ethan-1-ol) in accordance with an embodiment.

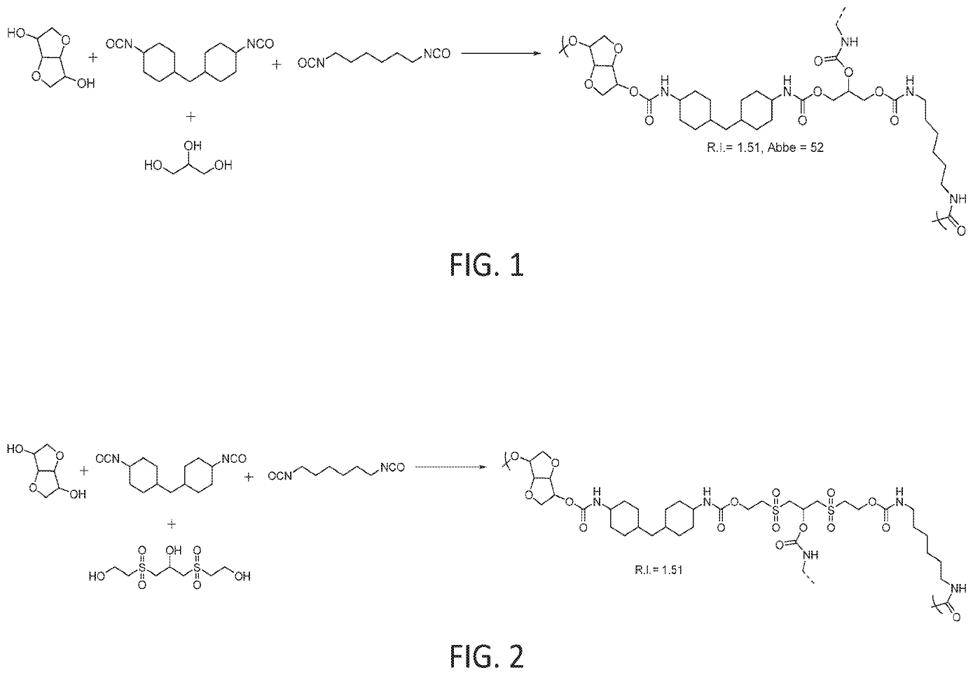

### DETAILED DESCRIPTION

### I. General

Provided herein are crosslinked copolymers that, when employed in the manufacture of optical components such as corrective eyeglass lenses, provide advantageous improvements in the optical and mechanical properties of such components. For example, it is beneficial for optical materials to have high indexes of refraction of 1.5 to greater than 1.8, low chromatic aberrations as determined by an Abbe number of less than 45, and high tensile strengths and excellent hardness as determined by impact resistance tests (as per FDA guidelines). The inventors have now discovered that these properties can be achieved by crosslinking polymers that have been formed from monomers derived from the renewable sugar resource sorbitol. In particular, it has been found that the use of trifunctional linkers to create crosslinked optical copolymers from monomer species such as isosorbide and its isomers and derivatives produces high strength materials that have a refractive index of greater than 1.5 and an Abbe value greater than 45. These new bioplastics are highly compatible with existing processes, techniques, and equipment for producing lens blanks and finished lenses.

Without being bound to a particular theory, it is believed that the mechanical properties of ophthalmic polymers can be related to the molecular weight of the polymers, with higher molecular weight polymers having improved tensile strength, tear resistance, and hardness. As a result of these enhanced mechanical properties, higher molecular weight polymers can be more amenable to downstream industrial lens making operations such as injection molding, compression molding, or prescription processing. In contrast, lower molecular weight polymers can have more linear and less entangled configurations, and can generate lenses that are more brittle and prone to shattering. The provided crosslinked copolymers have generally high molecular weights that allow the copolymers to be used with conventional lens making molding processes, while preserving the excellent optical properties of the sorbitol-based polymers being crosslinked.

### II. Copolymers

In one aspect, many crosslinked optical copolymers are provided. The crosslinked optical copolymers can include a monomer derived from sorbitol, and a trifunctional linker. As used herein, the term “polymer” refers to an organic substance composed of a plurality of repeating structural units (monomeric units) covalently linked to one another. As used herein, the term “copolymer” refers to a polymer derived from two or more monomeric species, as opposed to a homopolymer where only one monomer is used. For example, given monomeric species A and B, an alternating copolymer can have the form of -A-B-A-B-A-B-A-B-A-B. As an alternate example, given monomeric species A and B, a random copolymer can have the form of -A-A-B-A-B-B-A-B-A-A-A-B-B-B-B-A. As another example, given monomeric species A and B, a block copolymer can have the form of -(A-A-A)-(B-B-B)-(A-A-A)-(B-B-B)-(A-A-A)-. As used herein, the term “crosslinked” refers to the state of having two or more polymer chains interconnected to one another such that the two or more polymer chains become a single large macromolecule. As used herein, the term “linker” refers to a multifunctional compound that reacts with one reactive functional group on one compound, and at least one other reactive functional group on at least one other compound, thereby linking the two or more compounds to each other. A linker can be, for example, difunctional or trifunctional.

As used herein, the terms “optical polymer” and “optical copolymer” refer to polymer or copolymer materials having properties characterizing the materials as suitable for use in optical applications or as optical components. Examples of optical elements that can include optical polymers or copolymers include lenses, windows, diffusers, filters, polarizers, prisms, beam splitters, and optical fibers. Desirable optical properties vary with particular optical applications and can include, for example, high light transmittance, high refraction index, high Abbe value, low yellow index, and high hardness.

The refractive index of an optical material or medium is a dimensionless number describing the propagation of light through a material. The refractive index of a material is defined as the ratio of the speed of light in a vacuum to the phase velocity of light within the material. In this way, the refractive index of a material determines the degree to which light is bent, or refracted, when entering or exiting the material. When light moves from a material of one refractive index to a material with a different refractive index, the light is bent, with the amount of bending related to the difference between the refractive indexes of the two materials. Higher refractive index materials can therefore be particularly useful as optical lenses, by providing a larger amount of light refraction with a thinner lens than is possible using materials having a lower refractive index.

The refractive index value of the crosslinked optical copolymer can, for example, be from 1.5 to 1.75, e.g., from 1.5 to 1.65, from 1.525 to 1.675, from 1.55 to 1.7, from 1.575 to 1.725, or from 1.6 to 1.75. In terms of upper limits, the copolymer refractive index can be less than 1.75, e.g., less than 1.725, less than 1.7, less than 1.675, less than 1.65, less than 1.625, less than 1.6, less than 1.575, less than 1.55, or less than 1.525. In terms of lower limits, the copolymer refractive index can be greater than 1.5, e.g., greater than 1.525, greater than 1.55, greater than 1.575, greater than 1.6, greater than 1.625, greater than 1.65, greater than 1.675, greater than 1.7, or greater than 1.725.

If the index of refraction varies significantly with wavelength in the visible region, then an optical material, or a lens formed thereof, can suffer from chromatic aberrations. A lens with chromatic aberration can produce distorted images that lack clarity. One measure of the chromatic aberrations of a material is the Abbe number of the material. Abbe number refers to that constant of an optical medium which indicates a ratio of a refractive index of light to a dispersivity of the light. In other words, an Abbe number is a degree to which rays of light of varying wavelengths are refracted in different directions. The higher the Abbe number of an optical medium, the lower the dispersivity corresponding to a degree to which rays of light of varying wavelengths are refracted in different directions. The Abbe value (V_{D}) of a material is defined by the equation:

$${V}_{D} = \frac{{n}_{D} - 1}{{n}_{F} - {n}_{C}} ,$$

where n_{D}, n_{F}, and n_{C} are the refractive indexes of the material at the wavelengths of the Fraunhofer D-, F- and C-spectral lines (589.3 nm, 486.1 nm and 656.3 nm respectively).

The Abbe value of the crosslinked optical copolymer can, for example, be from 35 to 85, e.g., from 35 to 65, from 40 to 70, from 45 to 75, from 50 to 80, or from 55 to 85. In terms of upper limits, the copolymer Abbe value can be less than 85, e.g., less than 80, less than 75, less than 70, less than 65, less than 60, less than 55, less than 50, less than 45, or less than 40. In terms of lower limits, the copolymer Abbe value can be greater than 35, e.g., greater than 40, greater than 45, greater than 50, greater than 55, greater than 60, greater than 65, greater than 70, greater than 75, or greater than 80.

The sorbitol-derived monomer of the crosslinked optical copolymer can be isosorbide or a derivative or stereoisomer thereof. Isosorbide is a bicyclic diol derivative of sorbitol. The chemical structure of isosorbide is shown below.

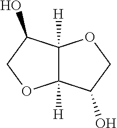

Stereoisomers of isosorbide include isoidide and isomannide. These two isomers differ from isosorbide in the spatial arrangement of the OH bonds with respect to the bicyclic five-membered rings. Each repeating unit of the copolymer can have a different stereoisomer of isosorbide. In some embodiments, isosorbide is the only sorbitol-derived monomer included in the crosslinked optical copolymer. In some embodiments, isoidide is the only sorbitol-derived monomer included in the crosslinked optical copolymer. In some embodiments, isomannide is the only sorbitol-derived monomer included in the crosslinked optical copolymer. In some embodiments, the crosslinked optical copolymer includes isosorbide and isoidide. In some embodiments, the crosslinked optical copolymer includes isosorbide and isomannide. In some embodiments, the crosslinked optical copolymer includes isoidide and isomannide. In some embodiments, the crosslinked optical copolymer includes isosorbide, isoidide, and isomannide.

The mole fraction of the sorbitol-derived monomer in the crosslinked optical copolymer can, for example, be from 40% to 50%, e.g., from 40% to 46%, from 41% to 47%, from 42% to 48%, from 43% to 49%, or from 44% to 50%. In terms of upper limits, the mole fraction of the sorbitol-derived monomer can be less than 50%, e.g., less than 49%, less than 48%, less than 47%, less than 46%, less than 45%, less than 44%, less than 43%, less than 42%, or less than 41%. In terms of lower limits, the mole fraction of the sorbitol-derived monomer can be greater than 40%, e.g., greater than 41%, greater than 42%, greater than 43%, greater than 44%, greater than 45%, greater than 46%, greater than 47%, greater than 48%, or greater than 49%. Lower mole fractions, e.g., mole fractions less than 40%, and higher mole fractions, e.g., mole fractions greater than 50%, are also contemplated.

The crosslinker of the crosslinked optical copolymer can be, for example, a trifunctional, tetrafunctional, or multifunctional linker molecule having reactive end groups. The trifunctional linker can be, for example, a triol, a triamine, a triisocyanate, a tricarboxylic acid, a triepoxide, or a trithiocarboxylic acid. In some embodiments, the crosslinked optical copolymer includes exactly one species of trifunctional linker. In some embodiments, the crosslinked optical copolymer includes exactly two species of trifunctional linkers. In some embodiments, the crosslinked optical copolymer includes three or more species of trifunctional linkers. The trifunctional linker can be a trifunctional compound having different terminal functional groups. For example, the terminal functional groups of the trifunctional linker can include any combination of three or fewer alcohol groups, three or fewer thiol groups, three or fewer amine groups, three or fewer isocyanate groups, three or fewer isothiocyanate groups, three or fewer carboxylic acid groups, and three or fewer thiocarboxylic acid groups, to give a total of three terminal functional groups. The trifunctional linker can include one or more cyclic or aromatic components that can be optionally unsubstituted or substituted. The trifunctional linker can be a linear molecule lacking cyclic or aromatic components. The linear chain of the linear trifunctional linker can also be optionally unsubstituted or substituted, and can have a chain length of 2, 3, 4, 5, 6, or more than 6 carbon atoms. The trifunctional linker can include one or more disulfide bonds.

In some embodiments, the trifunctional linker of the crosslinked optical copolymer is selected to be a triol, a trithiol, a triamine, or a triepoxide. In some embodiments, the trifunctional linker has a combination of alcohol and epoxide terminal functional groups. In some embodiments, the trifunctional linker has a combination of alcohol and amine terminal functional groups. In some embodiments, the trifunctional linker has a combination of amine and epoxide terminal functional groups. In some embodiments, the trifunctional linker has a combination of amine, alcohol, and epoxide terminal functional groups. These alcohol, amine, and epoxide groups can, for example, react with excess isocyanate or isothiocyanate present on an isosorbide-urethane polymer chain to form the crosslinked copolymer having a higher molecular weight.

The trifunctional linker of the crosslinked optical copolymer can be a triol. The triol can be, for example, glycerol, butanetriol, pentanetriol, hexanetriol, heptanetriol, octanetriol, nonanetriol, decanetriol, hydroxyquinol, phloroglucinol, pyrogallol, cyclohexanetriol, and substituted variants thereof. In some embodiments, the triol is a disulfone. In some embodiments, the disulfone is 2,2′-(2-hydroxypropane-1,3-diyldisulfonyl)bis(ethan-1-ol).

The mechanical properties of the crosslinked optical copolymer can depend in part on the amount of trifunctional linker used in its formation. The mole fraction of the trifunctional linker in the copolymer can, for example, be from 1% to 20%, e.g., from 1% to 12.4%, from 2.9% to 14.3%, from 4.8% to 16.2%, from 6.7% to 18.1%, or from 8.6% to 20%. In terms of upper limits, the mole fraction of the trifunctional linker can be less than 20%, e.g., less than 18.1%, less than 16.2%, less than 14.3%, less than 12.4%, less than 10.5%, less than 8.6%, less than 6.7%, less than 4.8%, or less than 2.9%. In terms of lower limits, the mole fraction of the trifunctional linker can be greater than 1%, e.g., greater than 2.9%, greater than 4.8%, greater than 6.7%, greater than 8.6%, greater than 10.5%, greater than 12.4%, greater than 14.3%, greater than 16.2%, or greater than 18.1%. Lower mole fractions, e.g., mole fractions less than 1%, and higher mole fractions, e.g., mole fractions greater than 20%, are also contemplated.

The crosslinked optical copolymer can also include one or more difunctional linkers. In some embodiments, the crosslinked optical copolymer includes exactly one species of difunctional linker. In some embodiments, the crosslinked optical copolymer includes exactly two species of difunctional linkers. In some embodiments, the crosslinked optical copolymer includes three or more species of difunctional linkers. The difunctional linkers can include, for example, one or more diisocyanates, diisothiocyanates, dicarboxylic acids, dithiocarboxylic acids, diesters, dithiols, cyclic anhydrides, or carbonates. The difunctional linkers can include difunctional compounds having different terminal functional groups. For example, the terminal functional groups of the difunctional linker can be an isocyanate group and a thioisocyanate group, an isocyanate group and a carboxylic acid group, an isocyanate group and a thiocarboxylic acid group, an isothiocyanate group and a carboxylic acid group, an isothiocyanate group and a thiocarboxylic acid group, or a carboxylic acid group and a thiocarboxylic acid group. The difunctional linker can include one or more cyclic or aromatic components that can be optionally unsubstituted or substituted. The difunctional linker can be a linear molecule lacking cyclic or aromatic components. The linear chain of the linear difunctional linker can also be optionally unsubstituted or substituted, and can have a chain length of 2, 3, 4, 5, 6, or more than 6 carbon atoms. The difunctional linker can include one or more disulfide bonds.

The one or more difunctional linkers of the crosslinked optical copolymer can include one or more dicarboxylic acids. The dicarboxylic acids can, for example, include one or more of 3,3′-disulfanediyldipropanoic acid, 2,2′-disulfanediyldiethanoic acid, or 4,4′-disulfanediyldibutanoic acid. The one or more difunctional linkers can include one or more dithiocarboxylic acids. The dithiocarboxylic acids can, for example, include one or more of succinthioic acid, 3,3′-disulfanediyldipropanthioic acid, 2,2′-disulfanediyldiethanthioic acid, or 4,4′-disulfanediyldibutanthioic acid. The one or more difunctional linkers can include a terminal carboxylic acid and a terminal thiocarboxylic acid, as in 4-((3-thiocarboxypropyl)disulfanyl)butanoic acid, 3-((2-thiocarboxyethyl)disulfanyl)propionic acid, 2-((thiocarboxymethyl)disulfanyl)acetic acid, and 4-hydroxy-4-thioxobutanoic acid.

The one or more difunctional linkers of the crosslinked optical copolymer can include one or more diisothiocyanates. A diisothiocyanate is a difunctional cyanate linker having the general structure shown below.

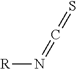

The diisothiocyanates can, for example, include one or more of bis(4-isothiocyanatocyclohexyl)methane, 1,6-diisothiocyanatohexane, bis(4-isothiocyanatophenyl)methane, 5-isothiocyanato-1-(isothiocyanatomethyl)-1,3,3-trimethylcyclohexane, 1,4-diisothiocyanatocyclohexane, 1,4-diisothiocyanatobutane, and 1,3-bis(isothiocyanatomethyl)cyclohexane.

The one or more difunctional linkers of the crosslinked optical copolymer can include one or more diisocyanates. A diisocyanate is a difunctional cyanate linker having the general structure shown below.

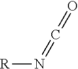

The diisocyanates can, for example, include one or more of bis(4-isocyanatocyclohexyl)methane (H₁₂MDI), 1,6-diisocyanatohexane (HMDI), bis(4-isocyanatophenyl)methane (MDI), 5-isocyanato-1-(isocyanatomethyl)-1,3,3-trimethylcyclohexane, 1,4-diisocyanatocyclohexane, 1,4-diisocyanatobutane, and 1,3-bis(isocyanatomethyl)cyclohexane. In some embodiments, the one or more difunctional linkers include H₁₂MDI. In some embodiments, the one or more difunctional linkers include HMDI. In some embodiments, the one or more difunctional linkers include bis(4-isocyanatophenyl)methane (MDI).

In some embodiments, the one or more difunctional linkers of the crosslinked optical copolymer include a diisocyanate and a diisothiocyanate. In some embodiments, the one or more difunctional linkers include two or more diisothiocyanates. In some embodiments, the one or more difunctional linkers include two or more diisocyanates. In some embodiments, the one or more difunctional linkers include a first diisocyanate and a second diisocyanate. In some embodiments, the first and second diisocyanates are H₁₂MDI and HMDI. In some embodiments, the first and second diisocyanates are H₁₂MDI and bis(4-isocyanatophenyl)methane (MDI). In some embodiments, the first and second diisocyanates are HMDI and bis(4-isocyanatophenyl)methane. In some embodiments, the first diisocyanate is MDI and the second is a mixture of diisocyanates H12MDI and HMDI.

The mole ratio of the first diisocyanate to the second diisocyanate in the crosslinked optical copolymer can, for example, be from 0.3 to 1.7, e.g., from 0.3 to 1.14, from 0.44 to 1.28, from 0.58 to 1.42, from 0.72 to 1.56, or from 0.86 to 1.7. In terms of upper limits, the mole ratio of the first diisocyanate to the second diisocyanate can be less than 1.7, e.g., less than 1.56, less than 1.42, less than 1.28, less than 1.14, less than 1, less than 0.86, less than 0.72, less than 0.58, or less than 0.44. In terms of lower limits, the mole ratio of the first diisocyanate to the second diisocyanate can be greater than 0.3, e.g., greater than 0.44, greater than 0.58, greater than 0.72, greater than 0.86, greater than 1, greater than 1.14, greater than 1.28, greater than 1.42, or greater than 1.56. Lower mole ratios, e.g., mole ratios less than 0.3, and higher mole ratios, e.g., mole ratios greater than 1.7, are also contemplated.

The combined mole fraction of the one or more difunctional linkers in the crosslinked optical copolymer can, for example, be from 40% to 60%, e.g., from 40% to 52%, from 42% to 54%, from 44% to 56%, from 46% to 58%, or from 48% to 60%. In terms of upper limits, the combined mole fraction of the one or more difunctional linkers can be less than 60%, e.g., less than 58%, less than 56%, less than 54%, less than 52%, less than 50%, less than 48%, less than 46%, less than 44%, or less than 42%. In terms of lower limits, the combined mole fraction of the one or more difunctional linkers can be greater than 40%, e.g., greater than 42%, greater than 44%, greater than 46%, greater than 48%, greater than 50%, greater than 52%, greater than 54%, greater than 56%, or greater than 58%. Lower mole fractions, e.g., mole fractions less than 40%, and higher mole fractions, e.g., mole fractions greater than 60%, are also contemplated.

The number average molecular weight of the crosslinked optical copolymer can, for example, be from 2000 to 50,000, e.g., from 2000 to 30,800, from 6800 to 35,600, from 11,600 to 40,400, from 16,400 to 45,200, or from 21,200 to 50,000. In terms of upper limits, the copolymer number average molecular weight can be less than 50,000, e.g., less than 45,200, less than 40,400, less than 35,600, less than 30,800, less than 26,000, less than 21,200, less than 16,400, less than 11,600, or less than 6800. In terms of lower limits, the copolymer number average molecular weight can be greater than 2000, e.g., greater than 6800, greater than 11,600, greater than 16,400, greater than 21,200, greater than 26,000, greater than 30,800, greater than 35,600, greater than 40,400, or greater than 45,200. Lower molecular weights, e.g., molecular weights less than 2000, and higher molecular weights, e.g., molecular weights greater than 50,000, are also contemplated.

The weight average molecular weight of the crosslinked optical copolymer can, for example, be from 4000 to 75,000, e.g., from 4000 to 46,600, from 11,100 to 53,700 from 18,200 to 60,800, from 25,300 to 67,900, or from 32,400 to 75,000. In terms of upper limits, the copolymer weight average molecular weight can be less than 75,000, e.g., less than 67,900, less than 60,800, less than 53,700, less than 46,600, less than 39,500, less than 32,400, less than 25,300, less than 18,200, or less than 11,100. In terms of lower limits, the copolymer weight average molecule weight can be greater than 4000, e.g., greater than 11,100, greater than 18,200, greater than 25,300, greater than 32,400, greater than 39,500, greater than 46,600, greater than 53,700, greater than 60,800, or greater than 67,900. Lower molecular weights, e.g., molecular weights less than 4000, and higher molecular weights, e.g., molecular weights greater than 75,000, are also contemplated.

The polydispersity index of the crosslinked optical copolymer can, for example, be from 1.2 to 2.7, e.g., from 1.2 to 2.1, from 1.35 to 2.25, from 1.5 to 2.4, from 1.65 to 2.55, or from 1.8 to 2.7. In terms of upper limits, the copolymer polydispersity index can be less than 2.7, e.g., less than 2.55, less than 2.4, less than 2.25, less than 2.1, less than 1.95, less than 1.8, less than 1.65, less than 1.5, or less than 1.35. In terms of lower limits, the copolymer polydispersity index can be greater than 1.2, e.g., greater than 1.35, greater than 1.5., greater than 1.65, greater than 1.8, greater than 1.95, greater than 2.1, greater than 2.25, greater than 2.4, or greater than 2.55. Lower polydispersity index values, e.g., polydispersity index values less than 1.2, and higher polydispersity index values, e.g., polydispersity index values greater than 2.7, are also contemplated.

### III. Methods

In another aspect, many methods for preparing a crosslinked optical copolymer are provided. The methods can include combining a monomer derived from sorbitol with one or more difunctional linkers to form a first reaction mixture. The sorbitol-derived monomer can be any of the monomers described above. The one or more difunctional linkers can each independently be any of the difunctional linkers described above.

The first reaction mixture can also include a metal catalyst. Non-limiting examples of metal catalysts suitable for use in the method include dibutyl tin oxide, dibutyl tin dilaurate, lithium hydroxide or a hydrate thereof, and combinations thereof. In some embodiments, the metal catalyst is an organotin compound. The organotin compound can be, for example, a tributyl tin, a trimethyl tin, a triphenyl tin, a tetrabutyl tin, a tricyclohexyl tin, a trioctyl tin, a tripropyl tin, a dibutyl tin, a dioctyl tin, a dimethyl tin, a monobutyl tin, or a monooctyl tin. In some embodiments, the organotin is a dibutyl tin. The organotin compound can be, for example, dibutyl tin dilaurate, dibutyl tin diacetate, or dibutyl tin dicarboxylate.

The mole ratio of the sorbitol-based monomer to the metal catalyst in the first reaction mixture can, for example, be from 80 to 90, e.g., from 80 to 86, from 81 to 87, from 82 to 88, from 83 to 89, or from 84 to 90. In terms of upper limits, the mole ratio of the sorbitol-based monomer to the metal catalyst can be less than 90, e.g., less than 89, less than 88, less than 87, less than 86, less than 85, less than 84. less than 83, less than 82, or less than 81. In terms of lower limits, the mole ratio of the sorbitol-based monomer to the metal catalyst can be greater than 80, e.g., greater than 81, greater than 82, greater than 83, greater than 84, greater than 85, greater than 86, greater than 87, greater than 88, or greater than 89. Lower mole ratios, e.g., mole ratios less than 80, and higher mole ratios, e.g., mole ratios greater than 90, are also contemplated.

The methods can further include reacting the first reaction mixture under conditions suitable for forming a polymer composed of the monomer and the one or more difunctional linkers. The conditions for the first reaction mixture can, for example, include a temperature of 60° C. to 90° C., e.g., from 60° C. to 78° C., from 63° C. to 81° C., from 66° C. to 84° C., from 69° C. to 87° C., or from 72° C. to 90° C. In terms of upper limits the first reaction mixture reaction temperature can be less than 90° C., e.g., less than 87° C., less than 84° C., less than 81° C., less than 78° C., less than 75° C., less than 72° C., less than 69° C., less than 66° C., or less than 63° C. In terms of lower limits, the first reaction mixture reaction temperature can be greater than 60° C., e.g., greater than 63° C., greater than 66° C., greater than 69° C., greater than 72° C., greater than 75° C., greater than 78° C., greater than 81° C., greater than 84° C., or greater than 87° C. Lower reaction temperatures, e.g., temperatures less than 60° C., and higher reaction temperatures, e.g., temperatures greater than 90° C., are also contemplated.

The methods can further include combining the polymer with a trifunctional linker to form a second reaction mixture. The trifunctional linker can be any of the trifunctional linkers described above. In some embodiments, the trifunctional linker of the second reaction mixture is a triol. In some embodiments, the trifunctional linker of the second reaction mixture is glycerol. In some embodiments, the trifunctional linker of the second reaction mixture is a disulfone. In some embodiments, the trifunctional linker of the second reaction mixture is 2,2′-(2-hydroxypropane-1,3-diyldisulfonyl)bis(ethan-1-01). In some embodiments, the trifunctional linker of the second reaction mixture is 1,2,3-propanetrithiol.

The methods can further include reacting the second reaction mixture under conditions suitable for forming a crosslinked polymer. The conditions for the second reaction mixture can, for example, include a temperature of 60° C. to 90° C., e.g., from 60° C. to 78° C., from 63° C. to 81° C., from 66° C. to 84° C., from 69° C. to 87° C., or from 72° C. to 90° C. In terms of upper limits the second reaction mixture reaction temperature can be less than 90° C., e.g., less than 87° C., less than 84° C., less than 81° C., less than 78° C., less than 75° C., less than 72° C., less than 69° C., less than 66° C., or less than 63° C. In terms of lower limits, the second reaction mixture reaction temperature can be greater than 60° C., e.g., greater than 63° C., greater than 66° C., greater than 69° C., greater than 72° C., greater than 75° C., greater than 78° C., greater than 81° C., greater than 84° C., or greater than 87° C. Lower reaction temperatures, e.g., temperatures less than 60° C., and higher reaction temperatures, e.g., temperatures greater than 90° C., are also contemplated.

The mechanical properties of the crosslinked optical copolymer can depend in part on the timing of adding the trifunctional linker to the other components of the polymer. For example, if the trifunctional linker is added relatively early in the copolymer preparation method, when small oligomers (e.g., oligomers having 10 or fewer repeating units) have been formed, then the final crosslinked polymer can be softer or harder, depending on the flexibility or rigidity of the monomer repeat units. If the trifunctional linker is added later in the copolymer preparation method, when larger oligomers (e.g., oligomers having approximately 25 repeating units) have been formed, then the final crosslinked polymer can less hard and rigid. If the trifunctional linker is added still later in the copolymer preparation method, when even larger oligomers (e.g., oligomers having 50 or more repeating units) have been formed, then the final crosslinked polymer can have a further reduced hardness and rigidity.

The methods can further include isolating the crosslinked optical copolymer from the second reaction mixture. Non-limiting examples of isolation techniques suitable for use in the method include chromatography, crystallization, precipitation, filtration, evaporation, and combinations thereof. In some embodiments, the methods include precipitating the crosslinked optical copolymer by adding the second reaction mixture to an organic solvent. In some embodiments, the organic solvent used to precipitate the crosslinked optical copolymer is methanol. In some embodiments, the polymer is isolated from the first reaction mixture before being added to the second reaction mixture. In some embodiments, the polymer is not isolated from the first reaction mixture before the formation of the second reaction mixture.

The methods can further include molding or shaping the crosslinked optical copolymer using any known means in the art. For example, the crosslinked optical polymer can be coated onto a wafer to form a film. The coating operations can include spin coating, rod coating, or any other known techniques in the art.

The refractive index value of the formed crosslinked optical copolymer can, for example, be from 1.5 to 1.75, e.g., from 1.5 to 1.65, from 1.525 to 1.675, from 1.55 to 1.7, from 1.575 to 1.725, or from 1.6 to 1.75. In terms of upper limits, the copolymer refractive index can be less than 1.75, e.g., less than 1.725, less than 1.7, less than 1.675, less than 1.65, less than 1.625, less than 1.6, less than 1.575, less than 1.55, or less than 1.525. In terms of lower limits, the copolymer refractive index can be greater than 1.5, e.g., greater than 1.525, greater than 1.55, greater than 1.575, greater than 1.6, greater than 1.625, greater than 1.65, greater than 1.675, greater than 1.7, or greater than 1.725.

The Abbe value of the formed crosslinked optical copolymer can, for example, be from 35 to 85, e.g., from 35 to 65, from 40 to 70, from 45 to 75, from 50 to 80, or from 55 to 85. In terms of upper limits, the copolymer Abbe value can be less than 85, e.g., less than 80, less than 75, less than 70, less than 65, less than 60, less than 55, less than 50, less than 45, or less than 40. In terms of lower limits, the copolymer Abbe value can be greater than 35, e.g., greater than 40, greater than 45, greater than 50, greater than 55, greater than 60, greater than 65, greater than 70, greater than 75, or greater than 80.

### IV. Optical Elements (Corrective Lenses)

In one aspect, optical elements configured as corrective lenses are provided. The optical elements configured as corrective lenses can include a crosslinked optical copolymer. The crosslinked optical copolymer can be any of the copolymers described above. In some embodiments, the corrective lens is configured for use in eyeglasses. Other lenses that can be produced using the provided crosslinked optical copolymer include components for microscopes, telescopes, binoculars, or cameras. The provided corrective lenses can also include contact lenses.

The polymers described herein can also be used to make other plastic products. In some embodiments, the polymers can be useful as components in light guides, fiber optics, adhesives, films, or sheets. In some embodiments, the polymers of the present disclosure can be useful for making sunglasses, magnifying glasses, concentrators for solar cells, prisms, windows, diffusers, filters, polarizers, beam splitters, or light covers.

### V. Examples

The following non-limiting examples of syntheses of crosslinked optical copolymers from isosorbide, H₁₂MDI, HMDI, and glycerol, and the results on the impact resistance test of some of the molded lenses are provided.

### Example 1. Synthesis of an Isosorbide Polyurethane

A 3-neck flask was charged with dried (recrystallized from methanol) isosorbide (0.006843 moles) and 5 mL dried dimethylacetamide (DMA) and the resulting mixture was stirred at 75° C. to dissolve the isosorbide. Into the solution, a mixture of bis(4-isocyanatocyclohexyl)methane (H₁₂MDI, 0.00515 moles) and 1,6-diisocyanatohexane (HMDI, 0.00515 moles) dissolved in 5 mL DMA was added dropwise over 10 minutes with stirring at room temperature. Dibutyl tin dilaurate (0.05 g, 8×10⁻⁹ moles) was then added, and the entire reaction mixture was purged with argon for 15 minutes followed by stirring at 75° C. The reaction became gel-like and viscous within 12 hours. The gel was poured into DMA and allowed to swell overnight. The swelled gel was poured into methanol. The precipitated polymer was washed with methanol several times and dried under vacuum at 80° C. to produce a white polymer with 80% yield. The refractive index value of the polymer was measured at 1.518, and the Abbe value of the polymer was measured as 52.4.

### Example 2. Synthesis of an Isosorbide Polyurethane

A 3-neck flask equipped with a mechanical stirrer was charged with dried (recrystallized from methanol) isosorbide (0.00684 moles) and 5 mL dried DMA and the resulting mixture was stirred at 70° C. to dissolve the isosorbide. Into the solution, a mixture of H₁₂MDI (0.00678 moles) and HMDI (0.000892 moles) dissolved in 5 mL DMA was added dropwise and stirred at room temperature. Dibutyl tin dilaurate (0.05 g, 8×10⁻⁹ moles) was then added, and the entire reaction mixture was purged with argon for 15 minutes followed by stirring at 75° C. The viscous solution was cooled to room temperature after 24 hours and poured into methanol to form a string-like white polymer. The solution was filtered through a 0.2-μm PTFE membrane filter into stirring methanol to precipitate out purified polymer. The methanol solution was filtered and the resulting polymer was dried under vacuum at 80° C. to produce a 75% yield. The refractive index value of the polymer was measured at 1.522, and the Abbe value of the polymer was measured as 49.4.

### Example 3. Synthesis of a Crosslinked Isosorbide Polyurethane

A 3-neck flask was charged with dried (recrystallized from methanol) isosorbide (0.0205 moles) and 9 mL dried dimethylacetamide (DMA) and the resulting mixture was stirred at 70° C. to dissolve the isosorbide. Into the solution, a mixture of bis(4-isocyanatocyclohexyl)methane (H₁₂MDI, 0.0115 moles) and 1,6-diisocyanatohexane (HMDI, 0.0115 moles) dissolved in 9 mL DMA was added dropwise over 10 minutes with stirring at room temperature. Dibutyl tin dilaurate (0.15 g, 0.00024 moles) was then added, and the entire reaction mixture was purged with argon for 15 minutes followed by stirring at 75° C. The solution became highly viscous within 30 minutes. An additional 10 mL of DMA was added and stirring was continued for 5 hours at 75° C. Glycerol (0.00238 moles) in 5 mL DMA was next added dropwise into the solution, which was then stirred for another 20 hours at 75° C. A highly viscous solution resulted after distilling off the DMA under vacuum. The viscous solution was poured into methanol to form a string-like white polymer. The solution was filtered and the polymer was dried. The crude polymer was dissolved again in DMA and filtered through a 0.2-μm polytetrafluoroethylene (PTFE) membrane filter into stirring methanol to precipitate out purified polymer. The methanol solution was filtered and the resulting polymer was dried under vacuum at 80° C. to produce a 75% yield. The polymer was found to have a number average molecular weight of 15,183, a weight average molecular weight of 28,382, and a polydispersity index value of 1.87. The refractive index value of the polymer was measured as 1.513, and the Abbe value of the polymer was measured as 52.4.

### Example 4. Synthesis of a Crosslinked Isosorbide Polyurethane

A 3-neck flask equipped with a mechanical stirrer was charged with dried (recrystallized from methanol) isosorbide (0.0684 moles) and 50 mL dried DMA and the resulting mixture was stirred at 70° C. to dissolve the isosorbide. Into the solution, a mixture of H₁₂MDI (0.0384 moles) and HMDI (0.0384 moles) dissolved in 20 mL DMA was added dropwise and stirred at room temperature. Dibutyl tin dilaurate (0.50 g, 0.00079 moles) was then added, and the entire reaction mixture was purged with argon for 15 minutes followed by stirring at 75° C. After 5 hours, glycerol (0.00793 moles) in 15 mL DMA was added dropwise into the viscous solution, which was then stirred for another 20 hours at 75° C. A highly viscous solution resulted after distilling off the DMA under vacuum. The viscous solution was poured into methanol to form a string-like white polymer. The solution was filtered and the polymer was dried. The crude polymer was dissolved again in DMA and filtered through a 0.2-μm PTFE membrane filter into stirring methanol to precipitate out purified polymer. The methanol solution was filtered and the resulting polymer was dried under vacuum at 80° C. to produce a 75% yield. The polymer was found to have a number average molecular weight of 22,209, a weight average molecular weight of 33,411, and a polydispersity index value of 1.50.

### Example 5. Synthesis of a Crosslinked Isosorbide Polyurethane

A 3-neck flask equipped with a mechanical stirrer was charged with dried (recrystallized from methanol) isosorbide (0.0205 moles) and 9 mL dried DMA and the resulting mixture was stirred at 70° C. to dissolve the isosorbide. Into the solution, a mixture of H₁₂MDI (0.0920 moles) and HMDI (0.0138 moles) dissolved in 9 mL DMA was added dropwise and stirred at room temperature. Dibutyl tin dilaurate (0.15 g, 0.00024 moles) was then added and the entire reaction mixture was purged with argon for 15 minutes followed by stirring at 75° C. The solution became highly viscous within 30 minutes. An additional 10 mL of DMA was added and stirring was continued for 5 hours at 75° C. Glycerol (0.00238 moles) in 5 mL DMA was next added dropwise into the viscous solution, which was then stirred for another 20 hours at 75° C. A highly viscous solution resulted after distilling off the DMA under vacuum. The viscous solution was poured into methanol to form a string like white polymer. The solution was filtered and the polymer was dried. The crude polymer was dissolved again in DMA and filtered through a 0.2-μm PTFE membrane filter into stirring methanol to precipitate out purified polymer. The methanol solution was filtered and the resulting polymer was dried under vacuum at 80° C. to produce a 75% yield. The polymer was found to have a number average molecular weight of 14,083, a weight average molecular weight of 23,858, and a polydispersity index value of 1.70.

### Example 6. Synthesis of a Crosslinked Isosorbide Polyurethane

A 3-neck flask equipped with a mechanical stirrer was charged with dried (recrystallized from methanol) isosorbide (0.0684 moles) and 50 mL dried DMA and the resulting mixture was agitated at 70° C. to dissolve the isosorbide. Into the solution, a mixture of H₁₂MDI (0.0307 moles) and HMDI (0.0460 moles) dissolved in 20 mL DMA was added dropwise and stirred at room temperature. Dibutyl tin dilaurate (0.50 g, 0.00079 moles) was added and the entire reaction mixture was purged with argon for 15 minutes followed by stirring at 75° C. The solution became highly viscous within 3 hours. An additional 18 mL of DMA was added and stirring was continued for another 2 hours at 75° C. Glycerol (0.00793 moles) in 15 mL DMA was next added dropwise into the solution, which was then stirred for another 20 hours at 75° C. A highly viscous solution resulted after distilling off the DMA under vacuum. The viscous solution was poured into methanol to form a string-like white polymer. The solution was filtered and the polymer was dried. The crude polymer was dissolved again in DMA and filtered through a 0.2-μm PTFE membrane filter into stirring methanol to precipitate out purified polymer. The methanol solution was filtered and the resulting polymer was dried under vacuum at 80° C. to produce a 75% yield.

### Example 7. Synthesis of a Crosslinked Isosorbide Polyurethane

A 3-neck flask equipped with a mechanical stirrer was charged with dried (recrystallized from methanol) isosorbide (0.0205 moles) and 9 mL dried DMA and the resulting mixture was agitated at 70° C. to dissolve the isosorbide. Into the solution, a mixture of H₁₂MDI (0.0092 moles) and HMDI (0.0138 moles) dissolved in 9 mL DMA was added dropwise with stirring at room temperature. Dibutyl tin dilaurate (0.15 g, 0.00024 moles) was then added, and the entire reaction mixture was purged with argon for 15 minutes followed by stirring at 75° C. The solution became highly viscous within 30 minutes. An additional 10 mL of DMA was added and continued stirring for 5 hours at 75° C. Glycerol (0.00435 moles) in 5 mL DMA was next added dropwise into the solution, which was then stirred for another 20 hours at 75° C. The viscous solution was poured into methanol to form a string-like white polymer. The solution was filtered and the polymer was dried. The crude polymer was dissolved again in DMA and filtered through a 0.2-μm PTFE membrane filter into stirring methanol to precipitate out purified polymer. The methanol solution was filtered and the resulting polymer was dried under vacuum at 80° C. to produce a 75% yield. The polymer was found to have a number average molecular weight of 12,958, a weight average molecular weight of 23,047, and a polydispersity index value of 1.78.

### Example 8. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0817 moles) and HMDI (0.0817 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added to the viscous solution after 15 minutes, followed by dropwise addition of glycerol (0.0234 moles) in 30 mL DMA. The reaction mixture turned highly viscous within one hour. The gel-like viscous solution was poured into methanol to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce at 98% yield.

### Example 9. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0817 moles) and HMDI (0.0817 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 30 minutes to the viscous solution, followed by dropwise addition of glycerol (0.0234 moles) in 30 mL DMA. The reaction mixture turned viscous and was then stirred at 75° C. for 20 hours. The viscous solution was poured into methanol to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce at 95% yield.

### Example 10. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0817 moles) and HMDI (0.0817 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 1 hour to the viscous solution, followed by dropwise addition of glycerol (0.0234 moles) in 30 mL DMA. The highly viscous solution was poured into methanol after 2 hours to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 98% yield. The lens made from this polymer has passed the FDA approved drop-ball test.

### Example 11. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0817 moles) and HMDI (0.0817 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 3 hours to the viscous solution, followed by dropwise addition of glycerol (0.0234 moles) in 30 mL DMA. The reaction mixture turned highly viscous and was poured into methanol after an additional 3 hours to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 95% yield.

### Example 12. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0654 moles) and HMDI (0.09804 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 15 minutes to the viscous solution, followed by dropwise addition of glycerol (0.0234 moles) in 30 mL DMA. The reaction mixture turned highly viscous within one hour. The gel-like viscous solution was poured into methanol to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 98% yield.

### Example 13. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0654 moles) and HMDI (0.09804 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 30 minutes to the viscous solution, followed by dropwise addition of glycerol (0.0234 moles) in 30 mL DMA. The reaction mixture turned viscous and was then stirred at 75° C. for another 20 hours. The viscous solution was poured into methanol to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 95% yield.

### Example 14. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0654 moles) and HMDI (0.09804 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 1 hour to the viscous solution, followed by dropwise addition of glycerol (0.0234 moles) in 30 mL DMA. The highly viscous solution was poured into methanol after 2 hours to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 98% yield. The lens made from this polymer has passed the FDA approved drop-ball test.

### Example 15. Synthesis of a Crosslinked Isosorbide Polyurethane

A 3-neck flask equipped with a mechanical stirrer was charged with isosorbide (0.1368 moles) and heated at 75° C. with bubbling of Argon for 1 hour, followed by the addition of 60 mL DMA. Into the solution, a mixture of H₁₂MDI (0.0654 moles) and HMDI (0.09804 moles) dissolved in 60 mL DMA was added dropwise with stirring at room temperature. Dibutyl tin dilaurate (1.00 g, 0.00158 moles) was then added, and the entire reaction mixture was bubbled with argon for 15 minutes followed by stirring at 75° C. An additional 120 mL of DMA was added after 3 hours to the viscous solution, followed by dropwise addition of glycerol (0.0234 moles) in 30 mL DMA. The reaction mixture turned highly viscous and was poured into methanol after an additional 5 hours to form a string-like white polymer. The solution was filtered and the polymer was dried. The crude polymer was dissolved again in approximately 500 mL DMA and the polymer was precipitated out from methanol. The methanol solution was filtered and the resulting white polymer was dried under vacuum at 80° C. to produce a 90% yield.

### Example 16. Impact Resistance Test (Drop-Ball)

The drop-ball test required by the FDA was performed on the lenses prepared from some of these polymers by compression molding to check the impact resistance of the lenses. According to the ANSI Z87.1 standard method, a ⅝-inch steel ball weighing approximately 0.56 ounces was dropped from a height of 50 inches upon the horizontal top surface of the lens rested on a hollow neoprene gasket. No visible cracks or micro fractures were observed after hitting the geometric center of the lens.

### Example 17. Synthesis of a Crosslinked Isosorbide Polyurethane

A 3-neck flask equipped with a mechanical stirrer was charged with Isosorbide (pre-activated under Argon at 85° C. for an hour) (0.6774 moles) and 300 mL dimethyl formamide (DMF) and the resulting mixture was stirred at 85° C. with bubbling of Argon gas to dissolve the Isosorbide. Into the solution, a mixture of H₁₂MDI (0.4902 moles) and HMDI (0.3268 moles) in 300 mL DMF was added dropwise over 10 minutes with stirring followed by the addition of dibutyl tin dilaurate (0.533 g, 8.44×10-4 moles). The entire solution was stirred at 85° C. with bubbling of Argon. The reaction mixture turned viscous within an hour. An additional 800 mL of DMF was added with continuous stirring. Glycerol (0.1195 moles) in 30 mL DMF was added dropwise to the reaction mixture and continued stirring the reaction mixture at 85° C. The solution formed an insoluble gel within 5 min. The additional solvent either was not enough for the reaction to continue without forming gel or the solvent DMF might have reacted with the diisocyanates to form undesirable crosslinked structure.

### Example 18. Synthesis of a Crosslinked Isosorbide Polyurethane

A 3-neck flask equipped with a mechanical stirrer was charged with Isosorbide (pre-activated under Argon at 85° C. for an hour) (0.6774 moles) and 300 mL dimethyl acetamide (DMA) and the resulting mixture was stirred at 85° C. with bubbling of Argon gas to dissolve the Isosorbide. Into the solution, a mixture of H₁₂MDI (0.4902 moles) and HMDI (0.3268 moles) in 300 mL DMA was added dropwise over 10 minutes with stirring followed by the addition of dibutyl tin dilaurate (0.533 g, 8.44×10-4 moles). The entire solution was stirred at 85° C. with bubbling of Argon. The reaction mixture turned viscous within an hour. An additional 800 mL of DMA was added with continuous stirring. Glycerol (0.1195 moles) in 30 mL DMA was added dropwise to the reaction mixture and continued stirring the reaction mixture at 85° C. The reaction mixture was cooled to room temperature after 30 min as the content turned highly viscous. The viscous solution was poured into cold methanol (3 L) with vigorous stirring to form a white polymer. The solution was then filtered and the polymer was dried. The crude polymer was dissolved in DMF (˜700 mL) and poured into methanol (3 L) to get a white polymer. The polymer was left inside a pool of methanol overnight to facilitate the diffusion of DMA out of the polymer. The polymer was then filtered and dried under vacuum at room temperature and dissolved in DMF. The DMF solution was filtered through a 5 μm PTFE membrane filter into stirring methanol (3 L) to precipitate out the pure polymer. The methanol solution was filtered and the resulting white polymer was dried under vacuum at 100° C. to yield 95% polymer.

### Example 19. Synthesis of a High Refractive Index Crosslinked Isosorbide Polyurethane

A 3-neck flask was charged with Isosorbide (pre-activated under Argon at 85° C. for an hour) (0.1274 moles) and 60 mL dimethyl acetamide (DMA) and the resulting mixture was stirred at 85° C. with bubbling of Argon gas to dissolve the Isosorbide. Into the solution, a mixture of 2,6-di-tert-butyl-4-methyl phenyl (1.82×10−3 mol) and tris (nonylphenyl)phosphite (5.80×10−4 mol) dissolved in 15 mL DMA was added. bis(4-isocyanatophenyl)methane (MDI) (0.0572 moles) dissolved in 15 mL DMA was added into the above solution and stirred the solution for an hour. A mixture of equimolar amount of H₁₂MDI (0.045 moles) and HMDI (0.045 moles) in 30 mL DMA was added dropwise over 10 minutes with stirring followed by the addition of dibutyl tin dilaurate (0.533 g, 8.44×10-4 moles). The entire solution was stirred at 85° C. with bubbling of Argon. The reaction mixture turned viscous progressively within 1-2 h. An additional 120 mL of DMA was added with continuous stirring. Glycerol (0.0202 moles) in 30 mL DMA was added dropwise to the reaction mixture and continued stirring the reaction mixture at 85° C. for an additional 15-30 min till a gel like viscous solution was formed. The content was poured into cold methanol (1 L) with vigorous stirring to form a white polymer. The solution was filtered and the polymer was dried. The crude polymer was redissolved in DMA (˜700 mL) and filtered through a 5 μm PTFE membrane filter into stirring methanol (1 L) to precipitate out the pure polymer. The methanol solution was filtered and the resulting white polymer was dried under vacuum at 100° C. to yield 60-85% polymer. The polyurethane has high refractive index as compared to the non-MDI version polyurethanes described above.

### Example 20. Synthesis of a High Refractive Index Crosslinked Isosorbide Polyurethane

A 3-neck flask was charged with Isosorbide (pre-activated under Argon at 85° C. for an hour) (0.1274 moles) and 60 mL dimethyl acetamide (DMA) and the resulting mixture was stirred at 85° C. with bubbling of Argon gas to dissolve the Isosorbide. Into the solution, a mixture of 2,6-di-tert-butyl-4-methyl phenyl (1.82×10−3 mol) and tris (nonylphenyl)phosphite (5.80×10−4 mol) dissolved in 15 mL DMA was added. bis(4-isocyanatophenyl)methane (MDI) (0.0586 moles) dissolved in 15 mL DMA was added into the above solution and stirred the solution for an hour. A mixture of equimolar amount of H₁₂MDI (0.0439 moles) and HMDI (0.0439 moles) in 30 mL DMA was added dropwise over 10 minutes with stirring followed by the addition of dibutyl tin dilaurate (0.533 g, 8.44×10-4 moles). The entire solution was stirred at 85° C. with bubbling of Argon. The reaction mixture turned viscous progressively within 1-2 h. An additional 120 mL of DMA was added with continuous stirring. Glycerol (0.01737 moles) in 30 mL DMA was added dropwise to the reaction mixture and continued stirring the reaction mixture at 85° C. for an additional 5 h till a highly viscous solution was formed. The content was poured into cold methanol (1 L) with vigorous stirring to form a white polymer. The solution was then filtered and the polymer was dried. The crude polymer was dissolved in DMA (˜700 mL) and filtered through a 5 μm PTFE membrane filter into stirring methanol (1 L) to precipitate out the pure polymer. The methanol solution was filtered and the resulting white polymer was dried under vacuum at 100° C. to yield 60-85% polymer. The polyurethane has high refractive index as compared to the non-MDI version polyurethanes described above.

Several diols and diisocyanates having high refractive index can be added to the system in order to increase both the refractive index and the Abbe value.

### Example 21. Creating an Ophthalmic Lens as an Optical Element of the Polyurethane Copolymers Described Herein

Preparation of a semifinished ophthalmic lens from polyurethane copolymer described herein.

A front glass mold of known radius of curvature and a back glass mold of known radius of curvature may be aligned along their periphery and held together by a thick Teflon gasket with rigid edge and an orifice where the Teflon gasket serves as the spacer for the final ophthalmic lens thickness. A known amount of molten polymer is squeezed carefully through the orifice into the sandwiched lens assembly. The glass mold assembly is then sandwiched between the heated platens in a compression press (such as Carver) for known period of time at 160-165° C. (above the polymer softening temperature) and under 100-500 pounds of pressure. After known period of time, the heating is stopped and the glass mold assembly is cooled to room temperature. The sandwiched assembly is separated and the molded semifinished ophthalmic lens is removed and evaluated for power and optical quality such as clarity and bumpiness using lensometer or automated evaluation equipment. The Teflon gasket can be 1-50 mm in height as long as it can withstand the temperature and pressure of molding. The height of the spacer controls the edge thickness of the molded semifinished lens while the two radii of curvatures of the glass molds (front and back) provide the center thickness. Alignment of the optical centers of the glass molds is important to yield the molded ophthalmic lens to be free of unwanted prism. Similar process can be used to mold a light guide, a fiber optic, a film, a sheet, sunglasses, magnifying glasses, concentrators for solar cells, and microscopic lenses.

### VI. Embodiments

The following embodiments are contemplated. All combinations of features and embodiments are contemplated.

Embodiment 1: A crosslinked optical copolymer comprising: a monomer derived from sorbitol; and a trifunctional linker; wherein the crosslinked optical copolymer has a refractive index value greater than 1.5 and an Abbe value greater than 45.

Embodiment 2: An embodiment of embodiment 1, wherein the monomer is isosorbide or a derivative or stereoisomer thereof.

Embodiment 3: An embodiment of embodiment 1 or 2, wherein the mole fraction of the monomer in the crosslinked optical polymer is from 40% to 50%.

Embodiment 4: An embodiment of any of the embodiments of embodiment 1-3, wherein the trifunctional linker is a triol or a trithiol.

Embodiment 5: An embodiment of embodiment 4, wherein the triol is glycerol.

Embodiment 6: An embodiment of embodiment 4, wherein the triol is a disulfone and the trithiol is 1,2,3-propanetrithiol.

Embodiment 7: An embodiment of embodiment 6, wherein the disulfone is 2,2′-(2-hydroxypropane-1,3-diyldisulfonyl)bis(ethan-1-ol).

Embodiment 8: An embodiment of any of the embodiments of embodiment 1-7, wherein the mole fraction of the trifunctional linker in the crosslinked optical copolymer is from 1% to 20%.

Embodiment 9: An embodiment of any of the embodiments of embodiment 1-8, further comprising: one or more difunctional linkers.

Embodiment 10: An embodiment of embodiment 9, wherein the one or more difunctional linkers are selected from the group consisting of diisocyanates and diisothiocyanates.

Embodiment 11: An embodiment of embodiment 10, wherein the diisocyanates are selected from the group consisting of bis(4-isocyanatocyclohexyl)methane (H₁₂MDI), 1,6-diisocyanatohexane (HMDI), bis(4-isocyanatophenyl)methane (MDI), 5-isocyanato-1-(isocyanatomethyl)-1,3,3-trimethylcyclohexane, 1,4-diisocyanatocyclohexane, 1,4-diisocyanatobutane, and 1,3-bis(isocyanatomethyl)cyclohexane.

Embodiment 12: An embodiment of embodiment 10 or 11, wherein the diisothiocyanates are selected from the group consisting of bis(4-isothiocyanatocyclohexyl)methane, 1,6-diisothiocyanatohexane, bis(4-isothiocyanatophenyl)methane, 5-isothiocyanato-1-(isothiocyanatomethyl)-1,3,3-trimethylcyclohexane, 1,4-diisothiocyanatocyclohexane, 1,4-diisothiocyanatobutane, and 1,3-bis(isothiocyanatomethyl)cyclohexane.

Embodiment 13: An embodiment of embodiment 9, wherein the one or more difunctional linkers comprise H₁₂MDI.

Embodiment 14: An embodiment of embodiment 9, wherein the one or more difunctional linkers comprise HMDI.

Embodiment 15: An embodiment of embodiment 9, wherein the one or more difunctional linkers comprise bis(4-isocyanatophenyl)methane (MDI).

Embodiment 16: An embodiment of embodiment 9, wherein the one or more difunctional linkers comprise a first diisocyanate and a second diisocyanate, and wherein the mole ratio of the first diisocyanate to the second diisocyanate in the crosslinked optical copolymer is from 0.3 to 1.7.

Embodiment 17: An embodiment of embodiment 16, wherein the first diisocyanate is H₁₂MDI and the second diisocyanate is HMDI.

Embodiment 18: An embodiment of embodiment 16, wherein the first diisocyanate is MDI and the second diisocyanate is H₁₂MDI and the third diisocyanate is HMDI.

Embodiment 19: An embodiment of any of the embodiments of embodiment 9-18, wherein the mole fraction of the one or more difunctional linkers in the crosslinked optical copolymer is from 40% to 60%.

Embodiment 20: An embodiment of any of the embodiments of embodiment 1-19, having a number average molecular weight from 2000 to 50,000.

Embodiment 21: An embodiment of any of the embodiments of embodiment 1-20, having a weight average molecular weight from 4000 to 75,000.

Embodiment 22: An embodiment of any of the embodiments of embodiment 1-21, having a polydispersity index from 1.2 to 2.7.

Embodiment 23: An optical element comprising the crosslinked optical copolymer of an embodiment of any of the embodiments of embodiment 1-22.

Embodiment 24: An embodiment of embodiment 23 configured for use in eyeglasses.

Embodiment 25: A method for preparing a crosslinked optical copolymer, the method comprising: (a) combining a monomer derived from sorbitol with one or more difunctional linkers to form a first reaction mixture; (b) reacting the first reaction mixture under conditions suitable for forming a polymer composed of the monomer and the one or more difunctional linkers; (c) combining the polymer with a trifunctional linker to form a second reaction mixture; and (d) reacting the second reaction mixture under conditions suitable for forming a crosslinked optical polymer, wherein the crosslinked optical polymer has a refractive index value greater than 1.5 and an Abbe value greater than 45.

Embodiment 26: An embodiment of embodiment 25, wherein the first reaction mixture comprises a metal catalyst.

Embodiment 27: An embodiment of embodiment 26, wherein the metal catalyst is an organotin compound.

Embodiment 28: An embodiment of embodiment 26 or 27, wherein the mole ratio of the monomer to the metal catalyst in the first reaction mixture is from 80 to 90.

Although the foregoing disclosure has been described in some detail by way of illustration and example for purpose of clarity of understanding, one of skill in the art will appreciate that certain changes and modifications may be practiced within the scope of the appended claims. In addition, each reference provided herein is incorporated by reference in its entirety for all purposes to the same extent as if each reference was individually incorporated by reference.

What is claimed is:

1. A crosslinked optical copolymer comprising:
a monomer derived from sorbitol; and
a trifunctional linker;
wherein the crosslinked optical copolymer has a refractive index value greater than 1.5 and an Abbe value greater than 45.

2. The crosslinked optical copolymer of claim 1, wherein the monomer is isosorbide or a derivative or stereoisomer thereof.

3. The crosslinked optical copolymer of claim 1, wherein the mole fraction of the monomer in the crosslinked optical polymer is from 40% to 50%.

4. The crosslinked optical copolymer of claim 1, wherein the trifunctional linker is a triol.

5. The crosslinked optical copolymer of claim 4, wherein the triol is glycerol.

6. The crosslinked optical copolymer of claim 4, wherein the triol is a disulfone.

7. The crosslinked optical copolymer of claim 6, wherein the disulfone is 2,2′-(2-hydroxypropane-1,3-diyldisulfonyl)bis(ethan-1-ol).

8. The crosslinked optical copolymer of claim 1, wherein the mole fraction of the trifunctional linker in the crosslinked optical copolymer is from 1% to 20%.

9. The crosslinked optical copolymer of claim 1, further comprising:
one or more difunctional linkers.

10. The crosslinked optical copolymer of claim 9, wherein the one or more difunctional linkers are selected from the group consisting of diisocyanates and diisothiocyanates.

11. The crosslinked optical copolymer of claim 10, wherein the diisocyanates are selected from the group consisting of bis(4-isocyanatocyclohexyl)methane (H₁₂MDI), 1,6-diisocyanatohexane (HMDI), bis(4-isocyanatophenyl)methane (MDI), 5-isocyanato-1-(isocyanatomethyl)-1,3,3-trimethylcyclohexane, 1,4-diisocyanatocyclohexane, 1,4-diisocyanatobutane, and 1,3-bis(isocyanatomethyl)cyclohexane.

12. The crosslinked optical copolymer of claim 10, wherein the diisothiocyanates are selected from the group consisting of bis(4-isothiocyanatocyclohexyl)methane, 1,6-diisothiocyanatohexane, bis(4-isothiocyanatophenyl)methane, 5-isothiocyanato-1-(isothiocyanatomethyl)-1,3,3-trimethylcyclohexane, 1,4-diisothiocyanatocyclohexane, 1,4-diisothiocyanatobutane, and 1,3-bis(isothiocyanatomethyl)cyclohexane.

13. The crosslinked optical copolymer of claim 9, wherein the one or more difunctional linkers comprise H₁₂MDI.

14. The crosslinked optical copolymer of claim 9, wherein the one or more difunctional linkers comprise HMDI.

15. The crosslinked optical copolymer of claim 9, wherein the one or more difunctional linkers comprise bis(4-isocyanatophenyl)methane (MDI).

16. The crosslinked optical copolymer of claim 9, wherein the one or more difunctional linkers comprise a first diisocyanate and a second diisocyanate, and wherein the mole ratio of the first diisocyanate to the second diisocyanate in the crosslinked optical copolymer is from 0.3 to 1.7.

17. The crosslinked optical copolymer of claim 16, wherein the first diisocyanate is H₁₂MDI and the second diisocyanate is HMDI.

18. The crosslinked optical copolymer of claim 9, wherein the mole fraction of the one or more difunctional linkers in the crosslinked optical copolymer is from 40% to 60%.

19. The crosslinked optical copolymer of claim 1, having a number average molecular weight from 2000 to 50,000.

20. The crosslinked optical copolymer of claim 1, having a weight average molecular weight from 4000 to 75,000.

21. The crosslinked optical copolymer of claim 1, having a polydispersity index from 1.2 to 2.7.

22. An optical element comprising the crosslinked optical copolymer of claim 1.

23. The optical element of claim 22 configured as a corrective lens for use in eyeglasses.

24. A method for preparing a crosslinked optical copolymer, the method comprising:
(a) combining a monomer derived from sorbitol with one or more difunctional linkers to form a first reaction mixture;
(b) reacting the first reaction mixture under conditions suitable for forming a polymer composed of the monomer and the one or more difunctional linkers;
(c) combining the polymer with a trifunctional linker to form a second reaction mixture; and
(d) reacting the second reaction mixture under conditions suitable for forming a crosslinked optical polymer, wherein the crosslinked optical polymer has a refractive index value greater than 1.5 and an Abbe value greater than 45.

25. The method of claim 24, wherein the first reaction mixture comprises a metal catalyst.

26. The method of claim 25, wherein the metal catalyst is an organotin compound.

27. The method of claim 25, wherein the mole ratio of the monomer to the metal catalyst in the first reaction mixture is from 80 to 90.
